(19) United States
(12) Patent Application Publication
(10) Pub. No.: US 2013/0127987 A1
(43) Pub. Date: May 23, 2013

(54) SIGNALING DEPTH RANGES FOR THREE-DIMENSIONAL VIDEO CODING

(71) Applicants: Li Zhang, San Diego, CA (US); Ying Chen, San Diego, CA (US); Marta Karczewicz, San Diego, CA (US)

(72) Inventors: Li Zhang, San Diego, CA (US); Ying Chen, San Diego, CA (US); Marta Karczewicz, San Diego, CA (US)

(73) Assignee: QUALCOMM INCORPORATED, San Diego, CA (US)

(21) Appl. No.: 13/586,688

(22) Filed: Aug. 15, 2012

Related U.S. Application Data
(60) Provisional application No. 61/561,800, filed on Nov. 18, 2011.
(60) Provisional application No. 61/563,771, filed on Nov. 26, 2011.
(60) Provisional application No. 61/569,134, filed on Dec. 9, 2011.

(51) Int. Cl. H04N 13/00

(52) U.S. Cl. 348/42; 348/E13.062

(57) ABSTRACT

In one example, a video coder, such as a video encoder or a video decoder, is configured to code a first set of one or more depth range values for a first set of video data, wherein the first set of one or more depth range values have respective first precisions, code a second set of one or more depth range values for a second set of video data, wherein the second set of one or more depth range values have respective second precisions different than the respective first precisions, and code at least a portion of the second set of video data using the second set of one or more depth range values. In this manner, the video coder may update precisions (e.g., numbers of bits) used to represent depth range values for coding multiview plus depth video data.

This application claims the benefit of U.S. Provisional Application No. 61/561,800, filed Nov. 18, 2011, U.S. Provisional Application No. 61/563,771, filed Nov. 26, 2011, and U.S. Provisional Application No. 61/569,134, filed Dec. 9, 2011, each of which is hereby incorporated by reference in its respective entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for coding depth range values for three-dimensional (3D) video coding. When coding 3D video data using both texture and depth information, providing an indication of a range for depth values of the depth information may be useful, both when coding and rendering the video data. In some cases, it may be beneficial to allow values used to code the depth ranges to have variable precision (that is, be expressed with a variable number of bits). This disclosure describes techniques for signaling the precision of values used to code depth range values, and techniques for coding depth range values using the new precision.

In one example, a method includes coding a first set of one or more depth range values for a first set of video data, wherein the first set of one or more depth range values have respective first precisions, coding a second set of one or more depth range values for a second set of video data, wherein the second set of one or more depth range values have respective second precisions different than the respective first precisions, and coding at least a portion of the second set of video data using the second set of one or more depth range values.

In another example, a device includes a video coder configured to code a first set of one or more depth range values for a first set of video data, wherein the first set of one or more depth range values have respective first precisions, code a second set of one or more depth range values for a second set of video data, wherein the second set of one or more depth range values have respective second precisions different than the respective first precisions, and code at least a portion of the second set of video data using the second set of one or more depth range values.

In another example, a device includes means for coding a first set of one or more depth range values for a first set of video data, wherein the first set of one or more depth range values have respective first precisions, means for coding a second set of one or more depth range values for a second set of video data, wherein the second set of one or more depth range values have respective second precisions different than the respective first precisions, and means for coding at least a portion of the second set of video data using the second set of one or more depth range values.

In another example, a computer-readable storage medium is encoded with instructions that, when executed, cause a programmable processor to code a first set of one or more depth range values for a first set of video data, wherein the first set of one or more depth range values have respective first precisions, code a second set of one or more depth range values for a second set of video data, wherein the second set of one or more depth range values have respective second precisions different than the respective first precisions, and code at least a portion of the second set of video data using the second set of one or more depth range values.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for signaling depth ranges in three-dimensional (3D) video coding.

FIG. 2 is a block diagram illustrating an example of a video encoder that may implement techniques for signaling depth ranges in 3D video coding.

FIG. 3 is a block diagram illustrating an example of a video decoder that may implement techniques for signaling depth ranges in 3D video coding.

FIG. 4 is a conceptual diagram illustrating an example set of images corresponding to an access unit.

FIG. 5 is a flowchart illustrating an example method for encoding multiview plus depth video data.

FIG. 6 is a flowchart illustrating an example method for decoding multiview plus depth video data.

### DETAILED DESCRIPTION

In general, this disclosure describes techniques for coding and processing multiview video data, e.g., video data used to produce a three-dimensional (3D) effect. Multiview video data may include both texture and depth information, where texture information generally describes luminance (brightness or intensity) and chrominance (color, e.g., blue hues and red hues) of a picture. Depth information may be represented by a depth map, in which individual pixels are assigned values that indicate whether corresponding pixels of the texture picture are to be displayed at the screen, relatively in front of the screen, or relatively behind the screen. These depth values may be converted into disparity values when synthesizing a picture using the texture and depth information. Furthermore, in accordance with the techniques of this disclosure, depth ranges for depth maps at different time instances may vary. Moreover, precision of depth values (e.g., a number of bits used to represent the depth values) may vary between depth maps at different time instances. As explained in greater detail below, techniques of this disclosure may be used to indicate whether precision for depth range values has changed, and if so, what the new precision is, and/or whether different pictures of a common time instance have the same depth range values.

To produce a three-dimensional effect in video, two views of a scene, e.g., a left eye view and a right eye view, may be shown simultaneously or nearly simultaneously. Two pictures of the same scene, corresponding to the left eye view and the right eye view of the scene, may be captured (or generated, e.g., as computer-generated graphics) from slightly different horizontal positions, representing the horizontal disparity between a viewer's left and right eyes. By displaying these two pictures simultaneously or nearly simultaneously, such that the left eye view picture is perceived by the viewer's left eye and the right eye view picture is perceived by the viewer's right eye, the viewer may experience a three-dimensional video effect.

This disclosure is related to 3D video coding based on advanced codecs, including the coding of two or more views of a picture with depth maps. In general, the techniques of this disclosure may be applied to any of a variety of different video coding standards. For example, these techniques may be applied to the multi-view video coding (MVC) extension of ITU-T H.264/AVC (advanced video coding), to a 3D video (3DV) extension of the upcoming High Efficiency Video Coding (HEVC) standard, or other coding standard. A recent draft of the upcoming HEVC standard is described in document HCTVC-11003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9th Meeting: Geneva, Switzerland, Apr. 27, 2012 to May 7, 2012, which, as of Aug. 6, 2012, is downloadable from http://phenix.it-sudparis.eu/jct/doc_end_user/documents/9_Geneva/wg11/JCTVC-I1003-v10.zip. For purposes of illustration, the techniques of this disclosure are described primarily with respect to either the MVC extension of ITU-T H.264/AVC or to the 3DV extension of HEVC. However, it should be understood that these techniques may be applied to other standards for coding video data used to produce a three-dimensional effect as well.

As noted above, MVC is an extension of ITU-T H.264/AVC. In MVC, data for a plurality of views is coded in time-first order, and accordingly, the decoding order arrangement is referred to as time-first coding. In particular, view components (that is, pictures) for each of the plurality of views at a common time instance may be coded, then another set of view components for a different time instance may be coded, and so on. An access unit may include coded pictures of all of the views for one output time instance. It should be understood that the decoding order of access units is not necessarily identical to the output (or display) order.

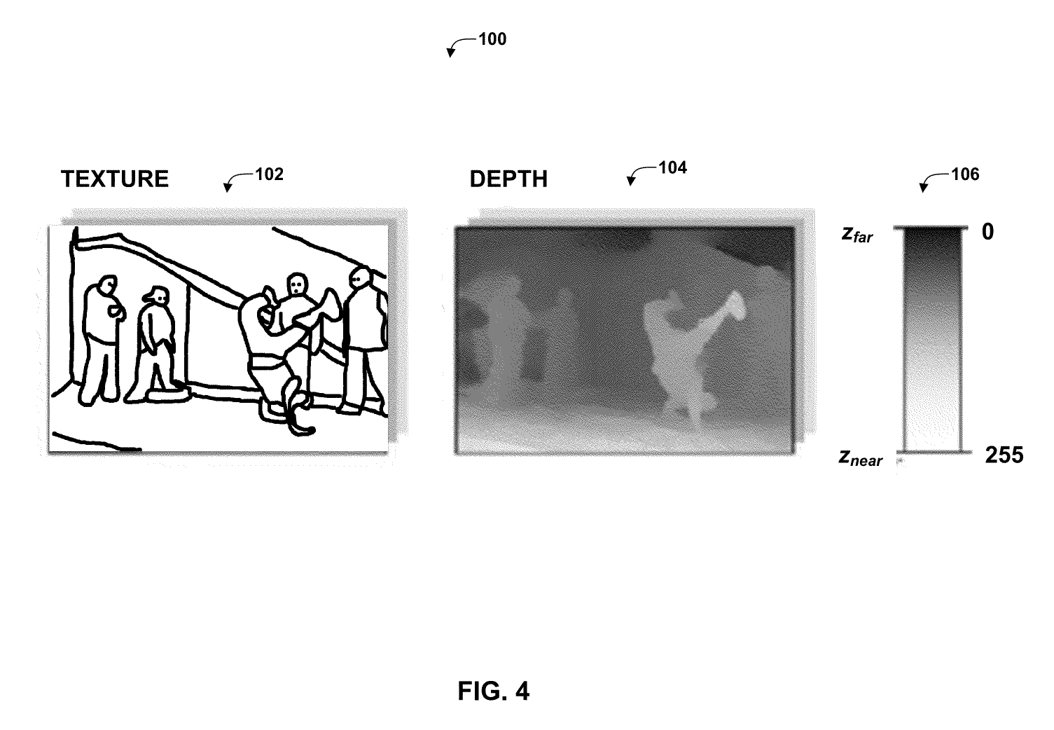

For the multiview-video-plus-depth (MVD) data format, which is popular for 3D television and free viewpoint videos, texture images and depth maps can be coded with MVC independently. FIG. 4, as discussed in greater detail below, illustrates the MVD data format with a texture image and its associated per-sample depth map. The depth range may be restricted to be in the range of minimum zₙₑₐᵣ and maximum z_{far} distance from the camera for the corresponding 3D points.

Camera parameters and depth range values may be helpful for processing decoded view components prior to rendering on a 3D display. Therefore, a special supplemental enhancement information (SEI) message is defined for the current version of H.264/MVC, i.e., multiview acquisition information SEI, which includes information that specifies various parameters of the acquisition environment. However, there are no syntaxes specified in H.264/MVC for indicating the depth range related information.

3D video (3DV) may be represented using the Multiview Video plus Depth (MVD) format, in which a small number of captured texture images of various views (which may correspond to individual horizontal camera positions), as well as associated depth maps, may be coded and the resulting bitstream packets may be multiplexed into a 3D video bitstream. Currently, ongoing 3D video standard activity in the Moving Picture Experts Group (MPEG) targets extending H.264/AVC to support the coding of MVD. Such a 3D video standard may by default use the H.264/MVC design, but more high level syntax extensions and coding tools may apply.

In some proposals for developing 3DV, syntax elements have been defined to support usage of camera parameters as well as the depth ranges for coding tools. For example, camera parameters and depth range may be signaled in a Sequence Parameter Set (SPS) 3DVC extension. Each value V of the camera parameter or depth range may be represented with its precision P, which is the number of digits before (if P is larger than 0) or after (if P is smaller than 0) the decimal point, and an integer value I, such that: V=I*10^{P}. The sign of V may be the same as I. Deferential coding may be applied between corresponding values of different views.

Furthermore, the depth ranges of the pictures may vary on a frame-by-frame basis. Accordingly, a parameter set, such as a Depth Parameter Set (DPS), may be used to signal the information indicative of the depth ranges of the pictures. A DPS may refer to an active SPS, and thus, only the difference of a new value and the original value in the SPS may be signaled in the DPS. That is, depth range values coded in a DPS may be predictively coded relative to depth range values of a corresponding SPS. In alternative examples, depth range values coded in a DPS may be predictively coded relative to depth range values of a previous DPS.

Table 1 below provides an example set of syntax for an SPS 3DVC extension.

TABLE 1

| | | |
|---|---|---|
| seq_parameter_set_3dvc_extension( ) { | C | Descriptor |

| | | |
|---|---|---|
| disable_depth_inter_view_flag | 0 | u(1) |
| pred_slice_header_depth_idc | 0 | u(2) |
| cam_parameters ( ) | | |
| depth_ranges ( ) | | |

}

Semantics for the syntax elements of Table 1 may be substantially the same as defined the current 3DVC proposal. In general, this data structure provides an indication of whether inter-view prediction for depth is permitted (disable_depth_inter_view_flag) and whether or how depth slice header information can be predicted from corresponding texture slice headers (pred_slice_header_depth_idc). Table 2 below provides syntax for cam_parameters( ) of Table 1, while Table 3 below provides syntax for depth_ranges( ) of Table 1.

TABLE 2

| cam_parameters( ) { | | C | Descriptor |
|---|---|---|---|
| | cam_param_present_flag | 0 | u(1) |
| | if ( cam_param_present_flag ) { | | |
| | //intrinsic parameters | | |

| | | |
|---|---|---|
| focal_length_precision | 0 | se(v) |
| focal_length_x_I | 0 | ue(v) |
| focal_length_y_I_diff_x | 0 | se(v) |
| principal_precision | 0 | se(v) |
| principal_point_x_I | 0 | se(v) |
| principal_point_y_I_diff_x | 0 | se(v) |

//extrinsic parameters

| | | |
|---|---|---|
| rotation_xy_half_pi | 0 | u(1) |
| rotation_xz_half_pi | 0 | u(1) |
| rotation_yz_half_pi | 0 | u(1) |
| translation_precision | 0 | se(v) |
| anchor_view_id | 0 | ue(v) |
| zero_translation_present_flag | 0 | u(1) |
| if (!zero_translation_present_flag ) | | |

| | | |
|---|---|---|
| translation_anchor_view_I | 0 | se(v) |

for( i = 0; i <= num_views_minus1; i++)

if (view_id[ i ]!= anchor_view_id)

| | | |
|---|---|---|
| translation_diff_anchor_view_I[ i ] | 0 | se(v) |

}

}

Semantics for the syntax elements of Table 2 may be defined as follows. Cam_param_present_flag equal to 1 may indicate that the camera parameters are signaled in this SPS, while cam_param_present_flag equal to 0 may indicate that the camera parameters are not signaled in this SPS. Focal_length_precision may specify the precision of the values of focal_length_x and focal_length_y, which are the focal lengths of all the cameras in the horizontal and vertical directions, respectively. Focal_length_x_I may specify the integer part of the value of focal_length_x. Focal_length_x may be calculated according to formula (1) below:

focal_length_{—}x=focal_length_{—}x_{—}I*10^{focal}^{_{—}}^{length}^{_{—}}^{precision} (1)

Focal_length_y_I_diff_x_plus focal_length_x_I may specify the integer part of the value of focal_length_y. Focal lengthy may be calculated according to formula (2) below:

focal_length_{—}y=(focal_length_{—}x_{—}I+focal_length_{—}y_{—}I_diff_{—}x)*10^{focal}^{_{—}}^{length}^{_{—}}^{precision} (2)

Principal_precision may specify the precision of the values of principal_point_x and principal_point_y, which are the principal point in the horizontal direction and principal point in the vertical direction of all the cameras. Principal_point_x_I may specify the integer part of the value of principal_point_x, which may be calculated according to formula (3) below:

principal_point_{—}x=principal_point_{—}x_{—}I*10^{principal}^{_{—}}^{precision} (3)

Principal_point_y_I_diff_x plus principal_point_x may specify the integer part of the value of principal_point_y, which may be calculated according to formula (4) below:

principal_point_{—}y=(principal_point_{—}x_{—}I+principal_point_{—}y_{—}I_diff_{—}x)*10^{principal}^{_{—}}^{precision} (4)

A rotation matrix R may be determined for each camera, and may be represented as follows:

$$R = [ \begin{matrix}{R}_{yz} & 0 & 0 \\ 0 & {R}_{xz} & 0 \\ 0 & 0 & {R}_{xy}\end{matrix} ] \qquad ( 5 )$$

Rotation_kl_half_pi may indicate the diagonal elements of the rotation matrix R, with kl equal to xy, yz, or xz (that is, klε{xy, yz, xz}), wherein Rₖₗ=(−1)^{rotation}^{_{—}}^{half}^{_{—}}^{pi}. This flag equal to 0 may indicate Rₖₗ=1; this flag equal to 1 may indicate R_{id}=−1. Translation_precision may specify the precision of the values of translations of all the views. The precision of translation values may apply to all the translation values of the views referring to this SPS. Anchor₁₃ view_id may specify the view_id of the view, the translation of which may be used as an anchor to calculate the translation of the other views. Zero_translation_present_flag equal to 1 may indicate that the translation of the view with view_id equal to anchor_view_id is 0; this value equal to 0 may indicate the translation of the view with view_id equal to anchor_view_id is signaled.

Translation_anchor_view_I may specify the integer part of the translation of the anchor view. Let the translation of the anchor view be denoted as translation_anchor_view. Translation_anchor_view may be equal to 0 when zero_translation_present_flag is equal to 0; otherwise, the translation may be calculated as shown in formula (6):

translation_anchor_view=translation_anchor_view_{—}I*10^{translation}^{_{—}}^{precision} (6)

Translation_diff_anchor_view_I[i] plus translation_anchor_view_I may specify the integer part of the translation of the view with view_id equal to view_id[i], denoted as translation_view_I[i]. Let the translation of the view with view_id equal to view_id[i] be denoted as translation_view[i]. Translation_view[i] may be calculated as shown in formula (7):

translation_view[i]=(translation_diff_anchor_view_{—}I[i]+translation_anchor_view_{—}I)*10^{translation}^{_{—}}^{precision} (7)

Table 3 below provides example syntax for depth_ranges( ) of Table 1:

TABLE 3

| depth_ranges( ) { | | C | Descriptor |
|---|---|---|---|
| | depth_range_present_flag | 0 | u(1) |
| | if (depth_range_present_flag ) { | | |
| | //depth range | | |

| | | |
|---|---|---|
| z_near_precision | 0 | se(v) |
| z_far_precision | 0 | se(v) |
| different_depth_range_flag | 0 | u(1) |
| anchor_view_id | 0 | ue(v) |
| z_near_integer | 0 | se(v) |
| z_far_integer | 0 | se(v) |
| if ( different_depth_range_flag ) | | |

for( i = 0; i <= num_views_minus1; i++)

if (view_id[ i ]!= anchor_view_id) {

| | | |
|---|---|---|
| z_near_diff_anchor_view_I[ i ] | 0 | se(v) |
| z_far_diff_anchor_view_I[ i ] | 0 | se(v) |

}

}

}

Semantics for the example syntax of Table 3 may be defined as follows. Depth_range_present_flag equal to 1 may indicate that the depth ranges for all the views are signaled in this SPS, while depth_range_present_flag equal to 0 may indicate that the depth ranges are not signaled in this SPS. Z_near_precision may specify the precision of a z_near value. The precision of z_near as specified in this SPS may apply to all the z_near values of the views referring to this SPS. Z_far_precision may specify the precision of a z_far value. The precision of z_far as specified in this SPS may apply to all the z_far values of the views referring to this SPS.

Different_depth_range_flag equal to 0 may indicate that the depth ranges of all the views are the same and are in the range of z_near and z_far, inclusive. Different_depth_range_flag equal to 1 may indicate that the depth ranges of all the views may be different: z_near and z_far are the depth range for the anchor view, and z_near[i] and z_far[i] are further specified in this SPS as the depth range of a view with view_id equal to view_id[i], assuming that there is at least one view for which the depth range is different than the depth range of the anchor view.

Z_near_integer may specify the integer part of the value of z_near for the anchor view. Z_near may be calculated according to formula (8) below:

z_near=z_near_integer*10^{z}^{_{—}}^{near}^{_{—}}^{precision} (8)

Z_far_integer may specify the integer part of the value of z_far for the anchor view. Z_far may be calculated according to formula (9) below:

z_far=z_far_integer*10^{z}^{_{—}}^{far}^{_{—}}^{precision} (9)

Z_near_diff_anchor_view_I plus z_near_integer may specify the integer part of the nearest depth value of the view with view_id equal to view_id[i], denoted as z_near_I[i]. Let the z_near value of the view with view_id equal to view_id[i] be denoted as z_near[i]. Z_near[i] may be calculated according to formula (10) below:

z_near[i]=(z_near_diff_anchor_view_{—}I[i]+z_near_integer)*10^{z}^{_{—}}^{near}^{_{—}}^{precision} (10)

Z_far_diff_anchor_view_I plus z_far_Integer may specify the integer part of the farthest depth value of the view with view_id equal to view_id[i], denoted as z_far[i]. Z_far[i] may be calculated according to formula (11) below:

z_far[i]=(z_far_diff_anchor_view_{—}I[i]+z_far_integer)*10^{z}^{_{—}}^{far}^{_{—}}^{precision} (11)

In general, coded video data may be encapsulated in a network abstraction layer (NAL) unit. NAL units may encapsulate video coding layer (VCL) data and non-VCL data. VCL data generally includes coded video data that is ultimately representative of prediction and residual data. Non-VCL data may include syntax data such as parameter set data and supplemental enhancement information (SEI) messages. NAL units may be assigned NAL unit types (represented as integer values) to generally indicate what type of data is encapsulated within the NAL unit. A NAL unit type of 16, for example, may encapsulate a depth parameter set, such as the depth parameter set of Table 4 below:

TABLE 4

| depth_parameter_set( ) { | | C | Descriptor |
|---|---|---|---|
| | seq_para_set_id | 0 | ue(v) |
| | for( i = 0; i <= numViewsMinus1; i++) { | | |

| | | |
|---|---|---|
| translation_update_view_I[ i ] | 0 | se(v) |
| z_near_update_view_I[ i ] | 0 | se(v) |
| z_far_update_view_I[ i ] | 0 | se(v) |

}
rbsp_trailing_bits( )

}

In general, syntax elements of a depth parameter set (DPS), such as that shown in Table 4, may be used to update the depth ranges and/or camera parameters of a sequence parameter set (SPS), such as an SPS in accordance with Table 1. The updated depth range or camera parameters of the DPS may be applicable to view components of a current access unit and view components following the access unit in the bitstream, until a new DPS or SPS following the current DPS updates those values. Semantics for the syntax elements of Table 4 may be defined as follows:

Seq_para_set_id may identify the SPS the current depth parameter set refers to. Translation_update_view_I[i] plus translation_view_I[i] (the integer part of translation_view[i]), may specify the integer part of the new value of translation_view[i]. The new value for translation_view[i] may be calculated according to formula (12) below:

translation_view[i]=(translation_view_{—}I[i]+translation_update_view_{—}I[i])*10^{translation}^{_{—}}^{precision} (12)

Z_near_update_view_I[i] plus z_near_I[i] (the integer part of z_near[i] as derived in the SPS) may specify the integer part of the new value of z_near[i]. The new value for z_near[i] may be calculated according to formula (13) below:

z_near[i]=(z_near_{—}I[i]+z_near_update_view_{—}I[i])*10^{z}^{_{—}}^{near}^{_{—}}^{precision} (13)

Z_far_update_view_I[i] plus z_far_I[i] (the integer part of z_far[i] as derived in the SPS) may specify the integer part of the new value of z_far[i]. The new value for z_far[i] may be calculated according to formula (14) below:

z_far[i]=(z_far_{—}I[i]+z_far_update_view_{—}I[i])*10^{z}^{_{—}}^{far}^{_{—}}^{precision} (14)

In this manner, the DPS of Table 4 may be used to update certain depth range values and/or certain camera parameter values of a corresponding SPS. However, values in the depth parameter set share the same precisions as those signaled in the corresponding SPS for depth range values. If the depth range values change dramatically, the precision defined in the SPS may not be appropriate for the new depth range values. Therefore, the techniques of this disclosure include signaling a variation in precision of depth range values when appropriate.

For example, the depth range parameter set of Table 4 may be modified to include a flag to indicate whether precisions for depth range values need to be updated. When the flag indicates that depth range values need to be updated, new depth range values may be provided (e.g., without reference to depth range values of the corresponding SPS), and in addition, new precision values (that is, values indicative of a number of bits to be used for the depth range values) may also be signaled. In this manner, video coding devices may code depth range values having different precisions than precisions of depth range values signaled in an SPS, and code values representative of the new precisions, in accordance with the techniques of this disclosure. That is, an additional mechanism may be enabled in a depth parameter set, wherein depth ranges may be signaled without referring to depth range values in an SPS. A flag may be signaled to indicate whether the mechanism is enabled. If the mechanism is enabled, depth range values may be directly signaled in the depth parameter set (which may also be referred to as a depth range parameter set).

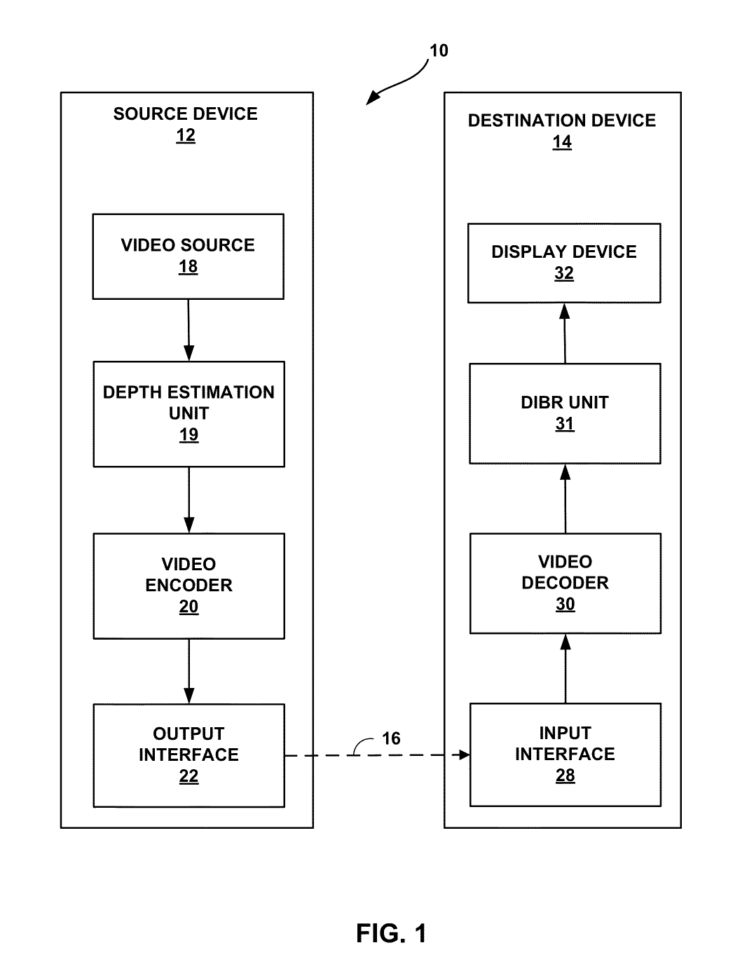

FIG. 1 is a block diagram illustrating an example video encoding and decoding system 10 that may utilize techniques for signaling depth ranges in three-dimensional (3D) video coding. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, depth estimation unit 19, video encoder 20, and output interface 22. Destination device 14 includes input interface 28, video decoder 30, depth image based rendering (DIBR) unit 31, and display device 32. In accordance with this disclosure, video encoder 20 of source device 12 may be configured to apply the techniques for signaling depth ranges in 3D video coding. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for signaling depth ranges in 3D video coding may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Video source 18 may provide multiple views of video data to video encoder 20. For example, video source 18 may correspond to an array of cameras, each having a unique horizontal position relative to a particular scene being filmed. Alternatively, video source 18 may generate video data from disparate horizontal camera perspectives, e.g., using computer graphics. Depth estimation unit 19 may be configured to determine values for depth pixels corresponding to pixels in a texture image. For example, depth estimation unit 19 may represent a Sound Navigation and Ranging (SONAR) unit, a Light Detection and Ranging (LIDAR) unit, or other unit capable of directly determining depth values substantially simultaneously while recording video data of a scene.

Additionally or alternatively, depth estimation unit 19 may be configured to calculate depth values indirectly by comparing two or more images that were captured at substantially the same time from different horizontal camera perspectives. By calculating horizontal disparity between substantially similar pixel values in the images, depth estimation unit 19 may approximate depth of various objects in the scene. Depth estimation unit 19 may be functionally integrated with video source 18, in some examples. For example, when video source 18 generates computer graphics images, depth estimation unit 19 may provide actual depth maps for graphical objects, e.g., using z-coordinates of pixels and objects used to render texture images.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device. In some examples, display device 32 may comprise a device capable of displaying two or more views simultaneously or substantially simultaneously, e.g., to produce a 3D visual effect for a viewer.

In accordance with the techniques of this disclosure, DIBR unit 31 of destination device 14 may render synthesized views using texture and depth information of decoded views received from video decoder 30. For example, DIBR unit 31 may determine horizontal disparity for pixel data of texture images as a function of values of pixels in corresponding depth maps. DIBR unit 31 may then generate a synthesized image by offsetting pixels in a texture image left or right by the determined horizontal disparity. In this manner, display device 32 may display one or more views, which may correspond to decoded views and/or synthesized views, in any combination. In accordance with the techniques of this disclosure, video decoder 30 may provide original and updated precision values for depth ranges and camera parameters to DIBR unit 31, which may use the depth ranges and camera parameters to properly synthesize views.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards, such as the MVC extension of ITU-T H.264/AVC. The techniques of this disclosure, however, are not limited to any particular coding standard. Other examples of video coding standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three angular intra-prediction encoding modes plus DC and Planar modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 and video decoder 30 may be configured to code texture and depth information when coding a multiview video bitstream. The texture information may include luminance and chrominance information, while the depth information may include a depth map. Pixels of the depth map may generally describe depth for corresponding pixels of the texture information. In accordance with the techniques of this disclosure, video encoder 20 and video decoder 30 may be configured to code depth ranges, and precisions of values for depth ranges. The precisions may comprise, for example, a number of bits used to represent values for the depth ranges.

As described with respect to Tables 1-3 above, video encoder 20 and video decoder 30 may be configured to code depth range values and precisions of the depth range values in a sequence parameter set. In addition, video encoder 20 and video decoder 30 may be configured to code a depth parameter set (or depth range parameter set) that updates either or both of the depth range values and/or precisions used to represent the depth range values. For example, video encoder 20 and video decoder 30 may be configured to code a depth parameter set in accordance with Table 5 below:

TABLE 5

| depth_parameter_set( ) { | | C | Descriptor |
|---|---|---|---|
| | seq_para_set_id | 0 | ue(v) |
| | depth_range_precision_update_flag | 0 | u(1) |
| | for( i = 0; i <= numViewsMinus1; i++) { | | |

| | | |
|---|---|---|
| translation_update_view_I[ i ] | 0 | se(v) |
| if(! depth_range_precision_update_flag) { | | |

| | | |
|---|---|---|
| z_near_update_view_I[ i ] | 0 | se(v) |
| z_far_update_view_I[ i ] | 0 | se(v) |

}

}
if (depth_range_precision_update_flag) {

| | | |
|---|---|---|
| z_near_precision_update | 0 | se(v) |
| z_far_precision_update | 0 | se(v) |
| different_depth_range_flag | 0 | u(1) |
| anchor_view_id | 0 | ue(v) |
| z_near_integer_update | 0 | se(v) |
| z_far_integer_update | 0 | se(v) |
| if ( different_depth_range_flag ) | | |

for( i = 0; i <= numViewsMinus1; i++)

if (view_id[ i ]!= anchor_view_id) {

| | | |
|---|---|---|
| z_near_diff_anchor_view_I_update [ i ] | 0 | se(v) |
| z_far_diff_anchor_view_I_update [ i ] | 0 | se(v) |

}

}
rbsp_trailing_bits( )

}

In the example of Table 5, certain syntax elements are similar to the syntax elements of Table 4. However, as shown in the example of Table 5, this example depth parameter set additionally includes a depth range precision update flag. Moreover, in the example of Table 5, certain other syntax elements are conditionally signaled based on the value of the depth range precision update flag. Semantics for the syntax elements of Table 5 may be defined as described below. That is, video encoder 20 and video decoder 30 may code values for these syntax elements based on the semantics defined as described below.

Seq_para_set_id may identify the SPS the current depth parameter set refers to. Depth_range_precision_update_flag equal to 1 may indicate that the depth ranges are directly signaled in the depth parameter set. Depth_range_precision_update_flag equal to 0 may indicate that the precision of depth ranges is the same as that signaled in SPS thus only the difference of integer values of depth ranges are signaled. Translation_update_view_I[i] plus translation_view_I[i] (the integer part of translation_view[i]), may specify the integer part of the new value of translation_view[i]. Translation_view[i] may be calculated according to formula (12) above, which is reproduced below:

translation_view[i]=(translation_view_{—}I[i]+translation_update_view_{—}I[i])*10^{translation}^{_{—}}^{precision} (12)

Z_near_update_view_I[i] plus z_near_I[i] (the integer part of z_near[i] as derived in the SPS) may specify the integer part of the new value of z_near[i] when depth_range_precision_update_flag is equal to zero. The new value for z_near[i] may be calculated according to formula (13) above, which is reproduced below:

z_near[i]=(z_near_{—}I[i]+z_near_update_view_{—}I[i])*10^{z}^{_{—}}^{near}^{_{—}}^{precision} (13)

Z_far_update_view_I[i] plus z_far_I[i] (the integer part of z_far[i] as derived in the SPS) may specify the integer part of the new value of z_far[i] when depth_range_precision_update_flag is equal to zero. The new value for z_far[i] may be calculated according to formula (14) above, which is reproduced below:

z_far[i]=(z_far_{—}I[i]+z_far_update_view_{—}I[i])*10^{z}^{_{—}}^{far}^{_{—}}^{precision} (14)

Z_near_precision update may specify the updated precision of a z_near value. If depth_range_precision_update_flag is equal to 1, the precision of z_near as specified in this DPS may apply to all the z_near values of the views referring to this DPS. Z_far_precision_update may specify the updated precision of a z_far value. If depth_range_precision_update_flag is equal to 1, the precision of z_far as specified in this DPS may apply to all the z_far values of the views referring to this DPS.

Different_depth_range_flag equal to 0 may indicate that the depth ranges of all the views are the same and are in the range of z_near and z_far, inclusive. Different_depth_range_flag equal to 1 may indicate that the depth ranges of all the views may be different: z_near and z_far, in this example, are the depth range for the anchor view, and z_near[i] and z_far[i] are further specified in this example DPS as the depth range of a view with view_id equal to view_id[i].

Z_near_integer_update may specify the updated integer part of the value of z_near for the anchor view when depth_range_precision_update_flag is equal to 1.

Z_near may be calculated according to formula (15) below:

z_near=z_near_integer_update*10^{z}^{_{—}}^{near}^{_{—}}^{precision}^{_{—}}^{update} (15)

Z_far_integer_update may specify the updated integer part of the value of z_far for the anchor view when depth_range_precision_update_flag is equal to 1. Z_far may be calculated according to formula (16) below:

z_far=z_far_integer_update*10^{z}^{_{—}}^{far}^{_{—}}^{precision}^{_{—}}^{update} (16)

Z_near_diff_anchor_view_I_update[i] plus z_near_integer_update may specify the integer part of the nearest depth value of the view with view_id equal to view_id[i] when depth_range_precision_update_flag is equal to 1. Z_near[i] may thus be calculated according to formula (17) below:

z_near[i]=(z_near_diff_anchor_view_{—}I_update[i]+z_near_integer_update)*10^{z}^{_{—}}^{near}^{_{—}}^{precision}^{_{—}}^{update} (17)

Z_far_diff_anchor_view_I_update plus z_far_Integer_update may specify the integer part of the farthest depth value of the view with view_id equal to view_id[i] when depth_range_precision_update_flag is equal to 1. Z_far[i] may thus be calculated according to formula (18) below:

z_far[i]=(z_far_diff_anchor_view_{—}I_update[i]+z_far_integer_update)*10^{z}^{_{—}}^{far}^{_{—}}^{precision}^{_{—}}^{update} (18)

Accordingly, video encoder 20 may determine whether pixel values of one or more depth maps, e.g., of a common access unit, have values for which a precision update is appropriate. For example, if the values of the depth pixels have increased or decreased by an amount greater than a threshold relative to the depth values of a previous picture, video encoder 20 may determine that a precision update is appropriate. After determining that a precision update is appropriate, video encoder 20 may code pixel values for depth maps using an updated precision value.

When coding a depth map, video encoder 20 may code the pixel values of the depth map in a manner similar to coding luminance values of a texture image. For example, video encoder 20 may code the pixel values using intra-prediction or inter-prediction. After performing a precision update, video encoder 20 may scale values of depth pixels in a reference depth map for inter-prediction, such that the depth pixels in the reference depth map have substantially the same precision as pixels in a depth map currently being coded. This scaling may produce a more accurate predicted value when coding a current depth map using inter-prediction. Moreover, as described above, video encoder 20 may encode a depth parameter set, such as that shown in Table 5, to code values representative of the updated precision and updated depth ranges. In addition, the updated depth parameters can be utilized during the view synthesis process to achieve a better visual quality.

Both depth range based weighted prediction (DBWP) and explicit weighted prediction (EWP) in AVC-based 3DV coding standard use the same equation of weighted prediction as follows:

$$\begin{matrix}{v}_{ref}^{′} = w \cdot {v}_{ref} + o \\ = \frac{1 / {Z}_{ref}^{near} - 1 / {Z}_{ref}^{far}}{1 / {Z}_{cur}^{near} - 1 / {Z}_{cur}^{far}} \cdot {v}_{ref} + 255 \cdot \frac{1 / {Z}_{ref}^{far} - 1 / {Z}_{cur}^{far}}{1 / {Z}_{cur}^{near} - 1 / {Z}_{cur}^{far}}\end{matrix}$$

where v′_{ref} is the reference picture after weighted prediction, v_{ref} is the reference picture before weighted prediction, and Zₙₑₐᵣ and Z_{far} are the depth range parameters, which represents the nearest depth value and the farthest depth value, respectively.

Similarly, video decoder 30 may receive a data structure, such as the DPS of Table 5. Using the DPS, video decoder 30 may determine new precisions for pixel values of subsequent depth maps, e.g., in a current access unit and subsequent access units, up to the next DPS or SPS, and also determine new depth range values from the DPS. Accordingly, video decoder 30 may use the newly determined precision values and depth range values to decode depth maps. For example, video decoder 30 may, as discussed above, scale pixel values of reference depth maps for a current depth map when performing inter-prediction decoding and when the depth range precisions and/or depth range values are different, e.g., with DBWP or EWP enabled. In this manner, video decoder 30 may decode a depth map using predicted values that are substantially the same as, if not identical to, values predicted by video encoder 20. Moreover, by adjusting the precision of the depth values, bits may be saved in the bitstream if less precision is needed, while more accurate values may be achieved using more bits when greater precision is needed.

In this manner, video encoder 20 and video decoder 30 may be configured to code a first set of one or more depth range values for a first set of video data, where the first set of one or more depth range values have respective first precisions. The first set of depth range values may correspond to, for example, an SPS or a previous DPS (e.g., a DPS coded for a previous access unit). The first set of video data may, accordingly, correspond to a sequence of view components (e.g., depth view components), which may include view components for any or all of the available views.

Additionally, video encoder 20 and video decoder 30 may be configured to code a second set of one or more depth range values for a second set of video data, where the second set of depth range values have second precisions different than the respective first precisions. The second set of depth range values may correspond to a DPS, such as a DPS following an SPS or, following a previous DPS, a subsequent DPS. Likewise, the second set of video data may correspond to a different access unit and pictures of that access unit and subsequent access units, up to a next DPS or SPS. In addition, video encoder 20 and video decoder 30 may code a depth range precision update flag that indicates that one or more of the precisions have been updated, as well as values for the updated (second) precisions.

Furthermore, video encoder 20 and video decoder 30 may be configured to code a portion of the second set of video data (e.g., depth maps, or portions of depth maps) using the second set of one or more depth ranges having the second precisions. For example, video encoder 20 and video decoder 30 may be configured to scale depth values of reference pictures according to the respective second precisions. Additionally or alternatively, video encoder 20 and video decoder 30 may use view synthesis prediction to code depth maps, where the view synthesis may be based at least in part on the depth range values having the respective second precisions.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

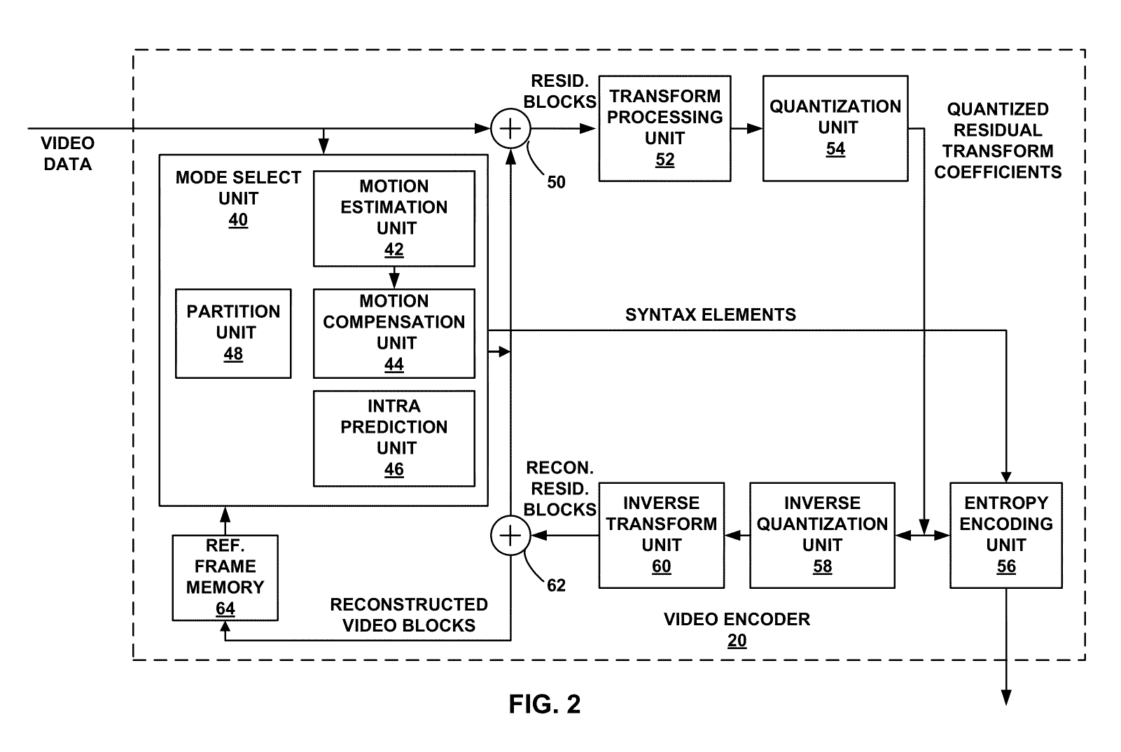

FIG. 2 is a block diagram illustrating an example of video encoder 20 that may implement techniques for signaling depth ranges in 3D video coding. Video encoder 20 may perform intra- and inter-coding of video blocks within video slices, e.g., slices of both texture images and depth maps. Texture information generally includes luminance (brightness or intensity) and chrominance (color, e.g., red hues and blue hues) information. In general, video encoder 20 may determine coding modes relative to luminance slices, and reuse prediction information from coding the luminance information to encode chrominance information (e.g., by reusing partitioning information, intra-prediction mode selections, motion vectors, or the like). Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block (that is, a block of video data, such as a luminance block, a chrominance block, or a depth block) within a video frame (e.g., a texture image or a depth map) to be encoded. In the example of FIG. 2, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit).

A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. In this manner, motion compensation unit 44 may reuse motion information determined for luma components to code chroma components such that motion estimation unit 42 need not perform a motion search for the chroma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients.

The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

Video encoder 20 may encode depth maps in a manner that substantially resembles coding techniques for coding luminance components, albeit without corresponding chrominance components. For example, intra-prediction unit 46 may intra-predict blocks of depth maps, while motion estimation unit 42 and motion compensation unit 44 may inter-predict blocks of depth maps. However, as discussed above, during inter-prediction of depth maps, motion compensation unit 44 may scale (that is, adjust) values of reference depth maps based on differences in depth ranges and precision values for the depth ranges. For example, if different maximum depth values in the current depth map and a reference depth map correspond to the same real-world depth, video encoder 20 may scale the maximum depth value of the reference depth map to be equal to the maximum depth value in the current depth map, for purposes of prediction. Additionally or alternatively, video encoder 20 may use the updated depth range values and precision values to generate a view synthesis picture for view synthesis prediction, e.g., using techniques substantially similar to inter-view prediction.

Video encoder 20 may further determine whether precisions for depth range values should be updated, e.g., as discussed above. Again, the precisions may correspond to a number of bits used to represent depth range values and pixel values in depth maps. In response to determining to update precisions for the depth range values, video encoder 20 may encode a depth parameter set, e.g., in accordance with Table 5 above. The depth parameter set may include a flag indicating whether the precisions have been updated, and if so, values for the updated precisions, as well as for the updated depth ranges. Video encoder 20 may code the updated depth range values relative to depth range values signaled in a corresponding SPS, that is, an SPS signaled for a sequence of pictures in which a current depth map occurs. Video encoder 20 may, in some examples, code up to one depth parameter set per access unit, such that depth maps in all views of a common temporal instance may be coded using information of the most recent DPS (or SPS, if no DPS has been coded since the most recent SPS).

In this manner, video encoder 20 of FIG. 2 represents an example of a video encoder configured to code a first set of one or more depth range values for a first set of video data, wherein the first set of one or more depth range values have respective first precisions, code a second set of one or more depth range values for a second set of video data, wherein the second set of one or more depth range values have respective second precisions different than the respective first precisions, and code at least a portion of the second set of video data using the second set of one or more depth range values.

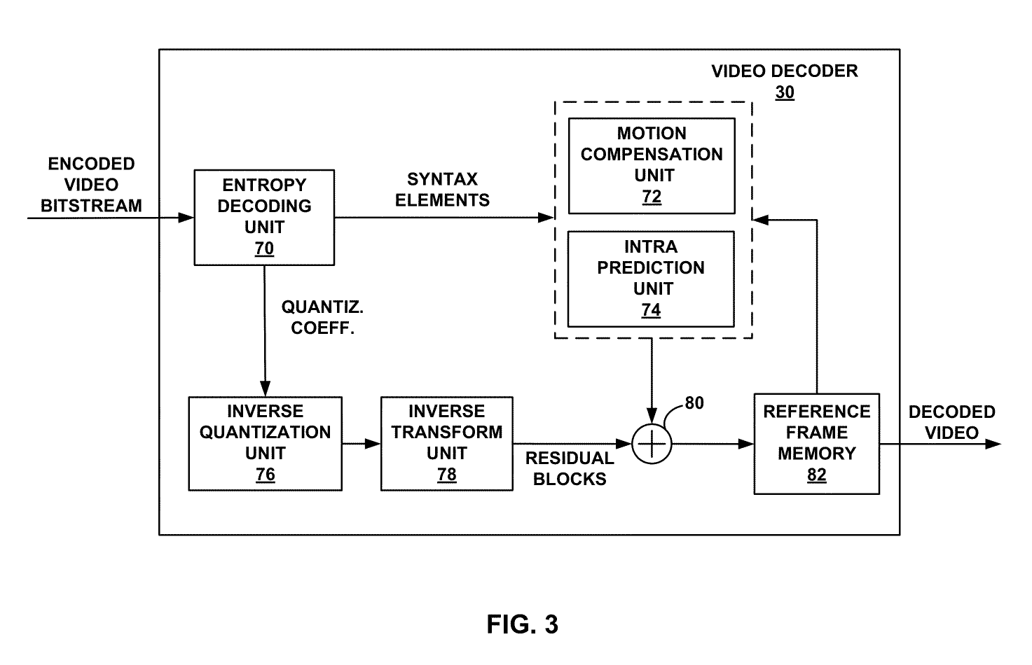

FIG. 3 is a block diagram illustrating an example of video decoder 30 that may implement techniques for signaling depth ranges in 3D video coding. In the example of FIG. 3, video decoder 30 includes an entropy decoding unit 70, motion compensation unit 72, intra prediction unit 74, inverse quantization unit 76, inverse transformation unit 78, reference frame memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference frame memory 82 also stores decoded video for later presentation on a display device, such as display device 32 of FIG. 1.

In accordance with the techniques of this disclosure, video decoder 30 may receive a depth parameter set, e.g., in accordance with Table 5 above, that indicates that precisions for depth range values of a current coded unit (e.g., a current access unit) have been updated. The depth parameter set may additionally or alternatively indicate that precisions for camera parameter values have been updated for the current coded unit (e.g., the current access unit). In this instance, the term “coded unit” should not be confused with the term “coding unit,” in that “coded unit” may represent any unit of coded video data, such as a slice, picture, sequence of pictures, or set of pictures across views at a common temporal location (e.g., an access unit), whereas a “coding unit” in HEVC represents a block of data including one or more PUs and one or more TUs.

In response to receiving a depth parameter set, video decoder 30 may use data of the depth parameter set when decoding depth maps of the current access unit and subsequent access units, up to the next DPS or SPS. As discussed above, motion compensation unit 72 may scale pixel values of reference depth maps when performing inter-prediction, based on depth ranges and precisions of depth range values signaled in the various DPSs for the current depth map and the reference depth map. Additionally or alternatively, video decoder 30 may use the updated depth range values and precision values to generate a view synthesis picture for view synthesis prediction, e.g., using techniques substantially similar to inter-view prediction.

In this manner, video decoder 30 of FIG. 3 represents an example of a video decoder configured to code a first set of one or more depth range values for a first set of video data, wherein the first set of one or more depth range values have respective first precisions, code a second set of one or more depth range values for a second set of video data, wherein the second set of one or more depth range values have respective second precisions different than the respective first precisions, and code at least a portion of the second set of video data using the second set of one or more depth range values.

FIG. 4 is a conceptual diagram illustrating an example set of images 100 corresponding to an access unit. Set of images 100 includes texture images 102 and corresponding depth maps 104. Texture images 102 may include luma and chroma (e.g., U and V) information, while depth maps 104 may include depth values for corresponding pixels of texture images 102. Depth range 106 provides numeric pixel values in the range [0, 255], and corresponding shading, for pixel values in depth maps 104, where relatively darker shaded pixels represent objects further from the camera (and, likewise, the viewer) while lighter shaded pixels represent objects closer to the camera.

Depth range values for depth maps 104 may be signaled in a depth parameter set, e.g., in accordance with Table 5, per the techniques of this disclosure. Likewise, depth range values and precisions for these depth range values for depth maps 104 may have changed relative to a previous indication of the precisions and depth range values, e.g., of a previous DPS or of a previous SPS. Thus, the values in a current DPS may be signaled relative to the previous SPS or the previous DPS.

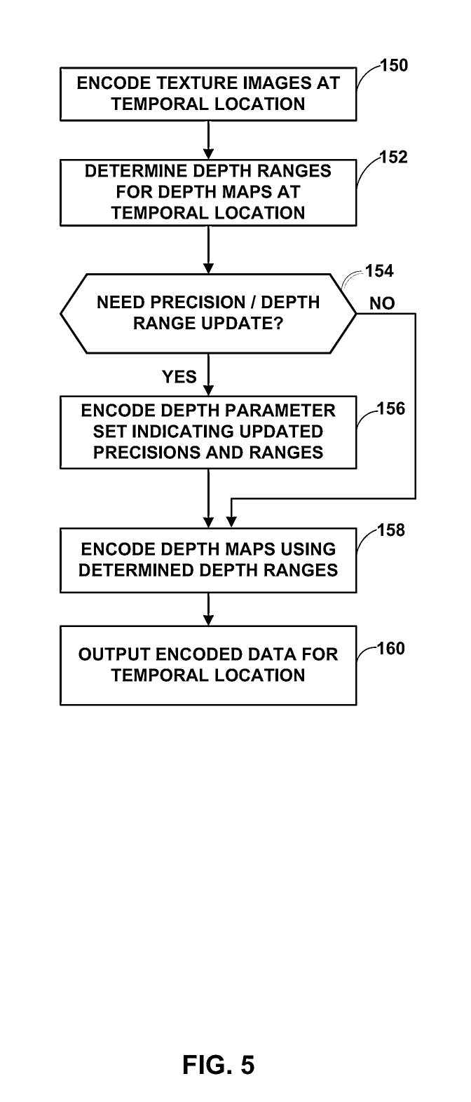

FIG. 5 is a flowchart illustrating an example method for encoding multiview plus depth video data. In particular, the method of FIG. 5 may be used by a video encoder, such as video encoder 20, to encode data of a current access unit, that is, data occurring at a particular temporal instance. It should be understood that this method may be performed repeatedly, to code data for each temporal instance. Thus, the method of FIG. 5 may have previously been performed for previous access units, which may correspond to an earlier set of video data.

For a current access unit, video encoder 20 may encode texture images at a particular temporal location (150). For example, video encoder 20 may receive texture images from a plurality of different views and encode these images, e.g., using intra-prediction, temporal inter-prediction, and/or inter-view prediction. Each of the texture images may include luminance and chrominance information. The texture images at the temporal location may ultimately correspond to a common access unit, as explained below.

Video encoder 20 may then determine depth ranges for depth maps at the temporal location (152). For example, video encoder 20 may analyze maximum and minimum pixel values for pixels of depth maps corresponding to the texture images. Video encoder 20 may determine whether depth range values for these depth maps is sufficiently different from previously coded depth maps as to warrant a precision and/or depth range update (154). Alternatively, video encoder 20 may determine whether the temporal location corresponds to a new instantaneous decoder refresh (IDR) picture, in which case video encoder 20 may determine that a new SPS needs to be coded, including new depth range values.

In any case, in response to determining that precision and/or depth range values should be updated (“YES” branch of 154), video encoder 20 may code a depth parameter set (DPS) indicating the updated precisions and depth ranges (156), e.g., in accordance with Table 5 above. When video encoder 20 determines that a precision update is needed, video encoder 20 may code a flag indicating that precision values have been updated, as well as coding values for the precisions for the depth range values. For example, video encoder 20 may code values for depth_range_precision_update_flag, z_near_update_view_I[i], z_far_update_view_I[i], z_near_precision_update, z_far_precision_update, different_depth_range_flag, anchor_view_id, z_near_integer_update, z_far_integer_update, z_near_diff_anchor_view_I_update [i], and/or z_far_diff_anchor_view_I_update [i] of Table 5.

Video encoder 20 may also code the depth maps based on the determined depth ranges (158). For example, if range and precision updates were not needed (“NO” branch of 154), video encoder 20 may code the depth maps using intra-prediction, temporal inter-prediction, or inter-view prediction (which may include view synthesis prediction). On the other hand, if range and precision updates were needed, video encoder 20 may, when performing temporal inter-prediction, scale values of reference pixel values, e.g., in a reference depth map, to code a current depth map, assuming that the depth ranges and/or precisions are different between the current depth map and the reference depth map. Video encoder 20 may then output the coded data (160), e.g., in the form of an access unit, which may include a DPS if the DPS was coded at step 156 above.

In this manner, the method of FIG. 5 represents an example of a method including coding a first set of one or more depth range values for a first set of video data, wherein the first set of one or more depth range values have respective first precisions, coding a second set of one or more depth range values for a second set of video data, wherein the second set of one or more depth range values have respective second precisions different than the respective first precisions, and coding at least a portion of the second set of video data using the second set of one or more depth range values. The first set of video data may correspond to a set of video data coded before the set of video data coded in the method of FIG. 5, e.g., following a previous SPS or a previous DPS. Video encoder 20 may repeat the method of FIG. 5 until all pictures at all temporal instances of the video bitstream have been coded.

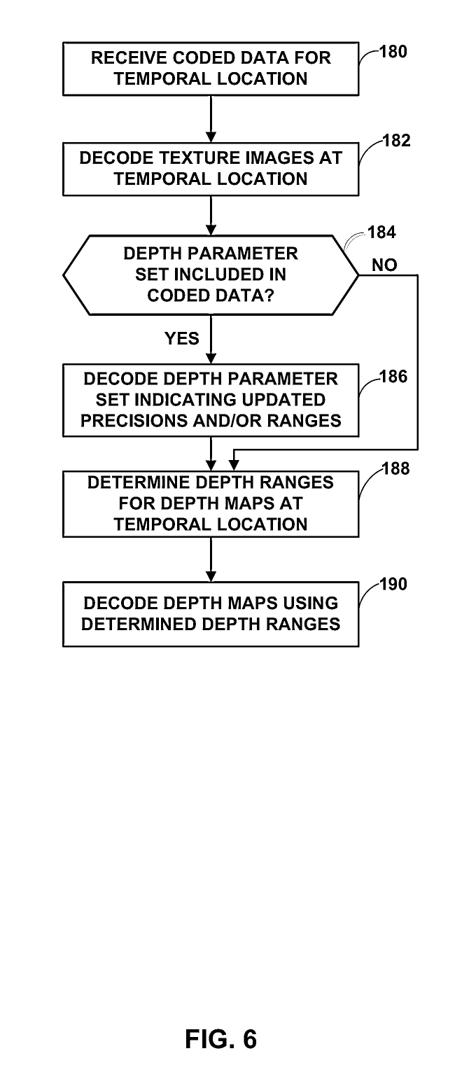

FIG. 6 is a flowchart illustrating an example method for decoding multiview plus depth video data. As with the example method of FIG. 5, it should be understood that the method of FIG. 6 may be performed by a video decoder, such as video decoder 30, repeatedly for a sequence of access units, e.g., sets of data at a particular temporal instance. Video decoder 30 may receive coded data for a temporal location (180). For example, video decoder 30 may receive an access unit including coded texture images and depth maps. Video decoder 30 may decode the texture images for the temporal location (182), e.g., using intra-prediction, temporal inter-prediction, or inter-view prediction (which may include view synthesis prediction).

Video decoder 30 may also determine whether a depth parameter set was included in the coded data, e.g., for the access unit (184). If a depth parameter set was included (“YES” branch of 184), video decoder 30 may decode the depth parameter set that indicates updated precisions for depth range values and/or updated depth ranges (186). Then, video decoder 30 may determine current depth ranges for depth maps at the temporal location, using either the current depth ranges and precisions (“NO” branch of 184) or the updated precisions and/or depth ranges signaled in the DPS.

Video decoder 30 may then decode the depth maps using the determined depth ranges (190). For example, if the depth ranges were updated for the current depth maps, and/or if precisions for the depth ranges were updated, video decoder 30 may scale pixel values of reference depth maps (which may include view synthesis reference depth maps generated using view synthesis prediction) when decoding a current depth map, e.g., a depth map of the current access unit. Although not shown in FIG. 6, in addition or in the alternative, video decoder 30 may provide the updated depth range values and/or updated precision values to a view synthesis unit, such as DIBR unit 31 (FIG. 1) to use to synthesize images of a view for which data was not coded.

In this manner, the method of FIG. 6 represents an example of a method including coding a first set of one or more depth range values for a first set of video data, wherein the first set of one or more depth range values have respective first precisions, coding a second set of one or more depth range values for a second set of video data, wherein the second set of one or more depth range values have respective second precisions different than the respective first precisions, and coding at least a portion of the second set of video data using the second set of one or more depth range values. The first set of video data may correspond to a set of video data coded before the set of video data coded in the method of FIG. 6, e.g., following a previous SPS or a previous DPS. Video decoder 30 may repeat the method of FIG. 6 until all pictures at all temporal instances of the video bitstream have been decoded.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
coding a first set of one or more depth range values for a first set of video data, wherein the first set of one or more depth range values have respective first precisions;
coding a second set of one or more depth range values for a second set of video data, wherein the second set of one or more depth range values have respective second precisions different than the respective first precisions; and
coding at least a portion of the second set of video data using the second set of one or more depth range values.

2. The method of claim 1, further comprising coding a depth range precision update flag having a value that indicates whether depth range precision has been changed for the second set of one or more depth range values.

3. The method of claim 2, wherein coding the second set of one or more depth range values comprises, when the depth range precision update flag indicates that the depth range precision has been updated, coding one or more precision update values representative of the respective second precisions.

4. The method of claim 2, wherein the second set of one or more depth range values comprise depth range values for an anchor view, the method further comprising, when the depth range precision update flag indicates that the depth range precision has been updated, coding one or more precision update values representative of the respective second precisions, coding a different depth range flag indicating whether a depth range for at least one view other than the anchor view has different depth range values than the depth range values for the anchor view.

5. The method of claim 4, further comprising coding a set of difference values for one or more depth range values for the at least one view relative to depth range values for the anchor view when the different depth range flag indicates that the depth range for the at least one view has different depth range values than the depth range values for the anchor view.

6. The method of claim 1, wherein the first set of video data comprises a sequence of pictures, wherein the second set of video data comprises an access unit including pictures for a plurality of views at a common temporal instance, and wherein at least one of the pictures in the access unit is included in the sequence of pictures.

7. The method of claim 6,
wherein coding the first set of one or more depth range values comprises coding a sequence parameter set, and
wherein coding the second set of one or more depth range values comprises coding a depth range parameter set.

8. The method of claim 1, wherein the first set of video data comprises a first access unit including a first set of pictures for a plurality of views at a first common temporal instance, wherein the second set of video data comprises a second access unit including a second set of pictures for the plurality of views at a second common temporal instance, and wherein the second temporal instance is different than the first temporal instance.

9. The method of claim 8,
wherein coding the first set of one or more depth range values comprises coding a first depth range parameter set, and
wherein coding the second set of one or more depth range values comprises coding a second depth range parameter set.

10. The method of claim 1, wherein coding the at least a portion of the second set of video data using the second set of one or more depth range values comprises:
adjusting pixel values of a reference picture of the first set of video data based on differences between the first set of one or more depth range values and the second set of one or more depth range values; and
coding the at least a portion of the second set of video data relative to the adjusted pixel values of the reference picture.

11. The method of claim 10, further comprising generating the reference picture using at least one of view synthesis prediction from the first set of video data, depth range based weighted prediction from the first set of video data, implicit weighted prediction from the first set of video data, and explicit weighted prediction from the first set of video data.

12. The method of claim 1, wherein coding the at least a portion of the second set of video data comprises decoding the at least a portion of the second set of video data.

13. The method of claim 1, wherein coding the at least a portion of the second set of video data comprises encoding the at least a portion of the second set of video data.

14. A device for coding video data, the device comprising a video coder configured to code a first set of one or more depth range values for a first set of video data, wherein the first set of one or more depth range values have respective first precisions, code a second set of one or more depth range values for a second set of video data, wherein the second set of one or more depth range values have respective second precisions different than the respective first precisions, and code at least a portion of the second set of video data using the second set of one or more depth range values.

15. The device of claim 14, wherein the video coder is further configured to code a depth range precision update flag having a value that indicates whether depth range precision has been changed for the second set of one or more depth range values.

16. The device of claim 15, wherein the video coder is configured to code, when the depth range precision update flag indicates that the depth range precision has been updated, one or more precision update values representative of the respective second precisions.

17. The device of claim 15, wherein the second set of one or more depth range values comprise depth range values for an anchor view, and wherein the video coder is configured to, when the depth range precision update flag indicates that the depth range precision has been updated, code one or more precision update values representative of the respective second precisions, and code a different depth range flag indicating whether a depth range for at least one view other than the anchor view has different depth range values than the depth range values for the anchor view.

18. The device of claim 14, wherein the first set of video data comprises a sequence of pictures, and wherein the second set of video data comprises an access unit including pictures for a plurality of views at a common temporal instance, wherein at least one of the pictures in the access unit is included in the sequence of pictures.

19. The device of claim 18, wherein the first set of one or more depth range values comprises a sequence parameter set, and wherein the second set of one or more depth range values comprises a depth range parameter set.

20. The device of claim 14, wherein the first set of video data comprises a first access unit including a first set of pictures for a plurality of views at a first common temporal instance, wherein the second set of video data comprises a second access unit including a second set of pictures for the plurality of views at a second common temporal instance, and wherein the second temporal instance is different than the first temporal instance.

21. The device of claim 20, wherein the first set of one or more depth range values comprises a first depth range parameter set, and wherein the second set of one or more depth range values comprises a second depth range parameter set.

22. The device of claim 14, wherein to code the at least a portion of the second set of video data using the second set of one or more depth range values, the video coder is configured to adjust pixel values of a reference picture of the first set of video data based on differences between the first set of one or more depth range values and the second set of one or more depth range values, and code the at least a portion of the second set of video data relative to the adjusted pixel values of the reference picture.

23. The device of claim 14, wherein the video coder comprises a video decoder.

24. The device of claim 14, wherein the video coder comprises a video encoder.

25. The device of claim 14, wherein the device comprises at least one of:
an integrated circuit;
a microprocessor; and
a wireless communication device that includes the video coder.

26. A device for coding video data, the device comprising:
means for coding a first set of one or more depth range values for a first set of video data, wherein the first set of one or more depth range values have respective first precisions;
means for coding a second set of one or more depth range values for a second set of video data, wherein the second set of one or more depth range values have respective second precisions different than the respective first precisions; and
means for coding at least a portion of the second set of video data using the second set of one or more depth range values.

27. The device of claim 26, further comprising coding a depth range precision update flag having a value that indicates whether depth range precision has been changed for the second set of one or more depth range values.

28. The device of claim 27, wherein the means for coding the second set of one or more depth range values comprises means for coding, when the depth range precision update flag indicates that the depth range precision has been updated, one or more precision update values representative of the respective second precisions.

29. The device of claim 27, wherein the second set of one or more depth range values comprise depth range values for an anchor view, further comprising:
means for coding one or more precision update values representative of the respective second precisions when the depth range precision update flag indicates that the depth range precision has been updated; and
means for coding a different depth range flag indicating whether a depth range for at least one view other than the anchor view has different depth range values than the depth range values for the anchor view when the depth range precision update flag indicates that the depth range precision has been updated.

30. The device of claim 26, wherein the first set of video data comprises a sequence of pictures, wherein the second set of video data comprises an access unit including pictures for a plurality of views at a common temporal instance, and wherein at least one of the pictures in the access unit is included in the sequence of pictures.

31. The device of claim 30,
wherein the means for coding the first set of one or more depth range values comprises means for coding a sequence parameter set, and
wherein the means for coding the second set of one or more depth range values comprises means for coding a depth range parameter set.

32. The device of claim 26, wherein the first set of video data comprises a first access unit including a first set of pictures for a plurality of views at a first common temporal instance, wherein the second set of video data comprises a second access unit including a second set of pictures for the plurality of views at a second common temporal instance, and wherein the second temporal instance is different than the first temporal instance.

33. The device of claim 32,
wherein the means for coding the first set of one or more depth range values comprises means for coding a first depth range parameter set, and
wherein the means for coding the second set of one or more depth range values comprises means for coding a second depth range parameter set.

34. The device of claim 26, wherein the means for coding the at least a portion of the second set of video data using the second set of one or more depth range values comprises:
means for adjusting pixel values of a reference picture of the first set of video data based on differences between the first set of one or more depth range values and the second set of one or more depth range values; and
means for coding the at least a portion of the second set of video data relative to the adjusted pixel values of the reference picture.

35. The device of claim 26, wherein the means for coding the at least a portion of the second set of video data comprises means for decoding the at least a portion of the second set of video data.

36. The device of claim 26, wherein the means for coding the at least a portion of the second set of video data comprises means for encoding the at least a portion of the second set of video data.

37. A computer-readable storage medium having stored thereon instructions that, when executed, cause a processor of a device for coding video data to:
code a first set of one or more depth range values for a first set of video data, wherein the first set of one or more depth range values have respective first precisions;
code a second set of one or more depth range values for a second set of video data, wherein the second set of one or more depth range values have respective second precisions different than the respective first precisions; and
code at least a portion of the second set of video data using the second set of one or more depth range values.

38. The computer-readable storage medium of claim 37, further comprising instructions that cause the processor to code a depth range precision update flag having a value that indicates whether depth range precision has been changed for the second set of one or more depth range values.

39. The computer-readable storage medium of claim 38, wherein the instructions that cause the processor to code the second set of one or more depth range values comprise instructions that cause the processor to, when the depth range precision update flag indicates that the depth range precision has been updated, code one or more precision update values representative of the respective second precisions.

40. The computer-readable storage medium of claim 38, wherein the second set of one or more depth range values comprise depth range values for an anchor view, further comprising instructions that cause the processor to, when the depth range precision update flag indicates that the depth range precision has been updated, code one or more precision update values representative of the respective second precisions, and code a different depth range flag indicating whether a depth range for at least one view other than the anchor view has different depth range values than the depth range values for the anchor view.

41. The computer-readable storage medium of claim 37, wherein the first set of video data comprises a sequence of pictures, wherein the second set of video data comprises an access unit including pictures for a plurality of views at a common temporal instance, and wherein at least one of the pictures in the access unit is included in the sequence of pictures.

42. The computer-readable storage medium of claim 41,
wherein the instructions that cause the processor to code the first set of one or more depth range values comprise instructions that cause the processor to code a sequence parameter set, and
wherein the instructions that cause the processor to code the second set of one or more depth range values comprise instructions that cause the processor to code a depth range parameter set.

43. The computer-readable storage medium of claim 37, wherein the first set of video data comprises a first access unit including a first set of pictures for a plurality of views at a first common temporal instance, wherein the second set of video data comprises a second access unit including a second set of pictures for the plurality of views at a second common temporal instance, and wherein the second temporal instance is different than the first temporal instance.

44. The computer-readable storage medium of claim 43,
wherein the instructions that cause the processor to code the first set of one or more depth range values comprise instructions that cause the processor to code a first depth range parameter set, and
wherein the instructions that cause the processor to code the second set of one or more depth range values comprise instructions that cause the processor to code a second depth range parameter set.

45. The computer-readable storage medium of claim 37, wherein the instructions that cause the processor to code the at least a portion of the second set of video data using the second set of one or more depth range values comprise instructions that cause the processor to:
adjust pixel values of a reference picture of the first set of video data based on differences between the first set of one or more depth range values and the second set of one or more depth range values; and
code the at least a portion of the second set of video data relative to the adjusted pixel values of the reference picture.

46. The computer-readable storage medium of claim 37, wherein the instructions that cause the processor to code the at least a portion of the second set of video data comprise instructions that cause the processor to decode the at least a portion of the second set of video data.

47. The computer-readable storage medium of claim 37, wherein the instructions that cause the processor to code the at least a portion of the second set of video data comprise instructions that cause the processor to encode the at least a portion of the second set of video data.
